(19) United States
(12) Patent Application Publication
(10) Pub. No.: US 2018/0359580 A1
(43) Pub. Date: Dec. 13, 2018

(54) CONVERSION AND DISTRIBUTION OF PUBLIC ADDRESS SYSTEM MESSAGES

(71) Applicant: Acoustic Protocol Inc., Kensington, MD (US)

(72) Inventor: Nir Aran, Washington, DC (US)

(21) Appl. No.: 16/003,922

(22) Filed: Jun. 8, 2018

Related U.S. Application Data
(60) Provisional application No. 62/516,964, filed on Jun. 8, 2017.

(51) Int. Cl. H04R 27/00; G06F 17/28

(52) U.S. Cl. CPC H04R 27/00; G06F 17/289

(57) ABSTRACT

Disclosed are implementations including a method for delivery of messaging content to individual subscribers. The method includes receiving an audio message broadcast by a public address (PA) system, and processing the audio message at least by converting the audio message to a resultant PA message, and analyzing one or more of the audio message or the resultant PA message to determine message information about the one or more of the audio message or the PA message. The method further includes identifying at least one subscriber based at least in part on a correspondence between one or more subscriber attributes and the message information associated with the audio message or the PA message, and transmitting to the identified at least one subscriber the one or more of the audio message or the resultant PA message.

### CROSS-REFERENCE TO RELATED APPLICATIONS

This application claims the benefit of U.S. Provisional Application No. 62/516,964, filed Jun. 8, 2017, the content of which is herein incorporated by reference in its entirety.

### BACKGROUND

The present disclosure relates to the conversion and distribution of audio messages provided over a public address system.

A public address (PA) system typically includes a microphone, amplifier, and loudspeakers that operate to provide sound amplification and distribution. For instance, a single person can use a public address system to broadcast audio messages across a large area such as an airport, train station, stadium, or hospital. But conventional PA systems are not always a reliable means for delivering information. Notably, audio messages broadcast over a PA system are often unintelligible. Moreover, an individual must be present within the perimeter of the PA in order to hear the messages broadcast by the PA system. Thus, the individual will miss the messages broadcast by the PA system if the individual is offsite and away from the vicinity of the PA system.

### SUMMARY

In a general aspect, audio messages from one or more PA systems can be processed at least by captioning (e.g., transcribing) and analyzing the audio messages to associate certain information (e.g., provided as metadata) therewith. A processed audio message (e.g., text, image) and/or a recording of the audio message can be selectively distributed to subscribers based on a correspondence between subscriber attributes and the information associated with the original or processed audio message (e.g., according to receiving criteria that are met by the user device that is to receive the processed audio message). Further matching operations to actually play a notification sent to a subscriber device may be performed at the device (e.g., by matching keywords, such as flight information indicated in the message, to data specific to the user and available at the device).

Thus, in some variations, a method for delivery of messaging content to individual subscribers is provided. The method includes receiving, by at least one processor-based device, an audio message broadcast by a public address (PA) system, and processing, by the at least one processor-based device, the audio message at least by converting the audio message to a resultant PA message, and analyzing one or more of the audio message or the resultant PA message to determine message information about the one or more of the audio message or the PA message. The method further includes identifying, by the at least one processor-based device, at least one subscriber based at least in part on a correspondence between one or more subscriber attributes and the message information associated with the audio message or the PA message, and transmitting, by the at least one processor-based device, to the identified subscriber, the one or more of the audio message or the resultant PA message.

Embodiments of the method may include at least some of the features described in the present disclosure, including one or more of the following features.

Converting the audio message may include transcribing at least a portion of a content of the audio message into one more of text or image.

The transcribing may be performed via an automated speech recognition.

analyzing the one or more of the audio message or the resultant PA message may include determining for the one or more of the audio message or the resultant PA message the message information indicating one or more of, for example, an origin of the audio message, a type of the audio message or the resultant PA message, one or more subscribers affected by the audio message or the resultant PA message, and/or one or more events affected by the one or more of the audio message or the resultant PA message.

Subscriber attributes may indicate one or more of, for example, a subscriber's current location, one or more points of interest, one or more events associated with the subscriber, and/or one or more applications installed on a device of the subscriber.

The method may further include translating the processed audio message into a plurality of different languages.

Transmitting of the audio message may include selecting a translation of the processed audio message in a language that is consistent with a language preference of the subscriber.

The method may further include receiving another audio message from a same or different PA system, and prioritizing a transmission of the audio message and the other audio message based at least in part on a respective type of the audio message and the other audio message.

The method may further include storing a recording of the one or more of the audio message or the resultant PA message, and providing the recording of the one or more of the audio message or the resultant PA message for an audit of the PA system.

In some variations, a system is provided that includes a communication transceiver to receive an audio message broadcast by a public address (PA) system, and a processor-based device, coupled to a memory device storing instructions executable on the processor-based device. The processor-based device implements a conversion module to convert the audio message to a resultant PA message, an analysis module to analyze one or more of the audio message or the resultant PA message to determine message information about the one or more of the audio message or the PA message, and a publishing module. The publishing module is configured to identify at least one subscriber based at least in part on a correspondence between one or more subscriber attributes and the message information associated with the audio message or the PA message, and cause the one or more of the audio message or the resultant PA message to be communicated to the identified subscriber.

Embodiments of the system may include at least some of the features described in the present disclosure, including at least some of the features described above in relation to the first method, as well as one or more of the following features.

The conversion module configured to convert the audio message may be configured to transcribe using automated speech recognition engine at least a portion of a content of the audio message into one more of text or image.

The analysis module configured to analyze the one or more of the audio message or the resultant PA message may be configured to determine for the one or more of the audio message or the resultant PA message the message information indicating one or more of, for example, an origin of the audio message, a type of the audio message or the resultant PA message, one or more subscribers affected by the audio message or the resultant PA message, and/or one or more events affected by the one or more of the audio message or the resultant PA message.

Subscriber attributes may indicate one or more of, for example, a subscriber's current location, one or more points of interest, one or more events associated with the subscriber, and/or one or more applications installed on a device of the subscriber.

The system may further include a translation module to translate the processed audio message into a plurality of different languages.

The system may further be configured to receive another audio message from a same or different PA system, and prioritize a transmission of the audio message and the other audio message based at least in part on a respective type of the audio message and the other audio message.

In some variations, a method is provided that includes providing, by a mobile device to a remote device, at least some subscriber attributes associated with one or more of a subscriber of the mobile device or the mobile device, and receiving, in response to a determination of a correspondence between one or more of the at least some subscriber attributes and message information associated with one or more of an audio message to be broadcast by a public address (PA) system or a resultant PA message converted from the audio message, the one or more of the audio message or the resultant PA message. The method further includes presenting the one or more of the audio message or the resultant PA message on a user output interface of the mobile device.

Embodiments of the method may include at least some of the features described in the present disclosure, including at least some of the features described above in relation to the first method and the system, as well as one or more of the following features.

Providing the at least some of the subscriber attributes may include providing one or more of, for example, a subscriber's current location, one or more points of interest, one or more events associated with the subscriber, and/or one or more applications installed on a device of the subscriber.

The message information may include one or more of, for example, an origin of the audio message, a type of the audio message or the resultant PA message, one or more subscribers affected by the audio message or the resultant PA message, and/or one or more events affected by the one or more of the audio message or the resultant PA message.

Receiving the one or more of the audio message or the resultant PA message may include receiving the one or more of the audio message or the resultant PA message in response to a determination of whether the subscriber's current location is within a predetermined radius from a geographic location corresponding to the original of the audio message.

Presenting the one or more of the audio message or the resultant PA message may include selecting, from a plurality of audio messages and PA messages received at the mobile device, at least one message to present on the user output interface, based on the subscriber attributes, wherein the subscriber attributes include one or more keyword determined to be associated with the subscriber.

Other features and advantages of the invention are apparent from the following description, and from the claims.

### BRIEF DESCRIPTION OF DRAWINGS

These and other aspects will now be described in detail with reference to the following drawings.

FIG. 1 is a schematic diagram illustrating of an example acoustic messaging system.

FIG. 2 is a flowchart illustrating an example process for converting and distributing PA system messages.

FIG. 3 is a flowchart of an example process for receiving PA notifications messages.

FIG. 4 is a schematic diagram of an example device (e.g., personal mobile device, or a server) that can perform the procedures and implementations described herein.

Like reference symbols in the various drawings indicate like elements.

### DETAILED DESCRIPTION

Described herein are systems, devices, methods, media, and other implementations for automated conversion and distribution of information. In particular, the subject matter described herein is directed to a selective distribution of information, originally provided as a public address (PA) audio message, via one or more alternative channels (e.g., texts, push notifications, haptic feedback). Some implementations include a method for distributing PA messages that includes receiving, by at least one processor-based device, an audio message broadcast by a public address (PA) system, processing, by the at least one processor-based device, the audio message at least by converting the audio message to a resultant PA message, and tagging one or more of the audio message or the resultant PA message. The method further includes identifying, by the at least one processor-based device, at least one subscriber based at least in part on a correspondence between one or more subscriber attributes and one or more tags associated with the audio message or the PA message, and transmitting, by the at least one processor-based device, to the identified subscriber, the one or more of the audio message or the resultant PA message. In another example implementation, a system is provided that includes a communication transceiver (e.g., with a wireless interface and/or a wired network interface) to receive an audio message broadcast by a public address (PA) system, and a processor-based device, coupled to a memory device storing instructions executable on the processor-based device. The processor-based device implements a conversion module to convert the audio message to a resultant PA message, a tagging module to tag one or more of the audio message or the resultant PA message, and a publishing module configured to identify at least one subscriber based at least in part on a correspondence between one or more subscriber attributes and one or more tags associated with the audio message or the PA message, and to cause the one or more of the audio message or the resultant PA message to be communicated to the identified subscriber.

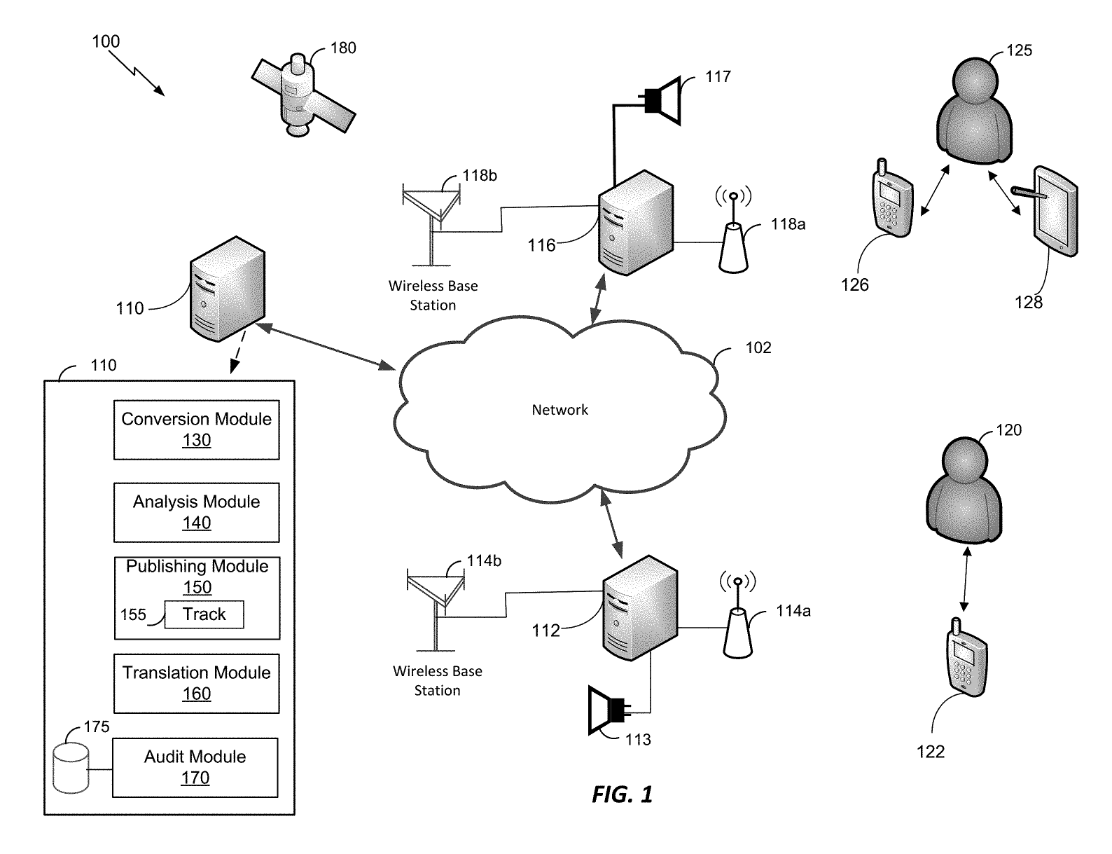

Thus, with reference to FIG. 1, a schematic diagram of an acoustic messaging system 100 consistent with implementations of the current subject matter, is shown. The acoustic messaging system 100 is communicatively coupled to a plurality of PA systems including, for example, a first PA system 112 and a second PA system 116. For instance, the first PA system 112 may be deployed at an airport while the second PA system 116 may be deployed at a stadium. The first and second PA systems/servers 112 and 116 may each be communicatively coupled to one or more network nodes (integrally connected to the systems 112 or 116, or modular nodes configured to be communicatively coupled to the systems 112 or 116). For example, the PA system 112, which may be a processor-based system, may be coupled to WLAN node (also referred to as an access point) 114a and/or WWAN node (also referred to as a base station) 114b, while the PA system 116 may be connected to WLAN node 118a and/or the WWAN node 118b. Each of the PA systems 112 and 116 of the acoustic messaging system 100 may be further connected to additional nodes (supporting different communication protocols or technologies, or associated with different service providers) that cover the same or different geographic area. Any of the depicted devices and nodes of the system 100, including the network nodes 114a-b and 118a-b, may be elements in various types of communications networks, including a wide area wireless network (WWAN), a wireless local area network (WLAN), a wireless personal area network (WPAN) configured for short-range communication, and so on.

Generally, a WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMax (IEEE 802.16), and so on. A CDMA network may implement one or more radio access technologies (RATs) such as cdma2000, Wideband-CDMA (W-CDMA), and so on. Cdma2000 includes IS-95, IS-2000, and/or IS-856 standards. A TDMA network may implement Global System for Mobile Communications (GSM), Digital Advanced Mobile Phone System (D-AMPS), or some other RAT. In some embodiments, 4G networks, Long Term Evolution (“LTE”) networks, Advanced LTE networks, Ultra Mobile Broadband (UMB) networks, 5G networks, and all other types of cellular and/or wireless communications networks may be implemented and used with the systems, methods, and other implementations described herein. The WWAN nodes used in conjunction with the system may otherwise be used to communicate according to any other type of WWAN protocol, including any 3GPP or IEEE standards (implemented over licensed and unlicensed frequency bands).

A WLAN may include, for example, an IEEE 802.11x network. A WPAN may include, for example, a Bluetooth network (including one based on Bluetooth Low Energy protocol), an IEEE 802.15x, RDID-based networks, other near-range communication networks, etc. While the example illustrated in FIG. 1 includes two wireless base stations and two shorter-range wireless nodes (which may include WLAN nodes), in other implementations the network environment or system illustrated in FIG. 1 may include more or fewer than the nodes 114a-bn and/or 118a-b.

The acoustic messaging 100 is configured to establish communication links with one or more devices operated or otherwise in the possession of a plurality of subscribers including, for example, a first subscriber 120 and a second subscriber 125. For example, the acoustic messaging system 100 can be configured to communicate with a first device 122 of the first subscriber 120. In another example, the acoustic messaging system 100 may be configured to communicate (e.g., via the nodes 118a-b coupled to the PA system 116) with multiple devices of the subscriber 125. For example, as shown in FIG. 1, the second subscriber 125 can be associated with a second device 126 and a third device 128. The subscriber devices may each be one of various types of mobile or user devices, including, for example, a tablet-type device (such as an iPad™), a smartphone device 120b (or any other type of a mobile device), a lap-top, a wearable device (e.g., a smartwatch) or any other device equipped with wireless communication modules that can establish a communication channel between the personal devices and the various nodes/devices constituting the system 100, including the PA systems 112 and 116, and/or the central controller 110 that is communicatively coupled to the PA systems 112 and 116. Thus, and as will be discussed in greater detailed below, the acoustic messaging system 100 is configured to establish communication channels (one-way channels, where messages are broadcast to receiving devices, or two-way communication channels between communicating nodes and personal user devices) to deliver PA messages (e.g., converted from speech input) to the receiving personal devices of selected subscribers (e.g., selected based on various criteria determined according to subscriber attributes and tags associated with PA messages).

As further shown in FIG. 1, the acoustic messaging system 100 can include a central controller 110 that includes a conversion module 130, an analysis module (also referred to as a tagging module) 140 , a publishing module 150, a translation module 160, and an audit module 170. As shown in FIG. 1. The central controller may be implemented as a remote server that can communicate with the PA system 112 and 116 (and/or other PA systems) via a network 102 (e.g., a packet-based network, which may be realized as a wireless network, a wired network, or a combination thereof). In some embodiments, each of the modules 130, 140, 150, 160, and 170 may be implemented as part of one the PA system 112 and/or 116 (different PA systems may have their own dedicated implementation of the modules described herein, or alternatively, the arrangements of the modules may be provided in a central location that can communicate with one or more of the PA systems 112 and 116, or any other PA system).

The acoustic messaging system 100 may, in some embodiments, passively receive messages from the first PA system 112 and/or the second PA system 116 via one or more recording units (not shown) installed on site with each of the first PA system 112 and/or the second PA system 116. For instance, a recording unit may be installed at the airport near one or more loudspeakers, such as a speaker 113, in the first PA system 112. Meanwhile, another recording unit may be installed at the stadium near one or more loudspeakers, such as a speaker 117, of the second PA system 116. Each recording unit may include line level inputs and/or dedicated microphones configured to capture audio messages broadcast by the first PA system 112 and the second PA system 116, respectively. As such, the acoustic messaging system 100 can passively receive recordings of audio/speech input broadcast by the first PA system 112 and the second PA system 116.

Alternately or additionally, the acoustic messaging system 100 can actively obtain messages broadcast by the first PA system 112 and/or the second PA system 116. The acoustic messaging system 100 can establish one or more active feeds from the first PA system 112 and/or the second PA system 116. For instance, the acoustic messaging system 100 can have one or more direct connections to an output auxiliary port of the first PA system 112 and/or the second PA system 116. As such, the acoustic messaging system 100 can actively obtain recordings of audio messages broadcast by the first PA system 112 and/or the second PA system 116. In another example, the PA systems 112 and/or 116 may receive audio data via a communication channel (e.g., from a phone or a computer-system that may be part of a private branch exchange (PBX), telephony network). In such embodiments, the acoustic messaging system (e.g., the central controller 110) may also be communicatively coupled (or integrated) to the PBX network to separately receive the transmitted audio data, and subsequently process and transmit the audio data, as will be discussed in greater detail below, to the personal devices of selected users.

In some implementations of the current subject matter, the conversion module 130 can be configured to convert audio input (e.g., audio or speech recordings provided by a front end that includes microphones) from the first PA system 112 and the second PA system 116, including by transcribing the audio or speech input into data representative of the speech (e.g., in the form of text). For example, the conversion module 130 can employ one or more speech recognition techniques (e.g., Hidden Markov, dynamic time warping, neural networks) to convert the audio messages (e.g., recordings) into PA message such as, for example, text data representative of the audio messages. Alternately or additionally, human operators may be engaged to convert the audio messages into text. Generally, the audio messages may also undergo some pre-processing filtering to remove noise, amplify the signals/data representative of the audio messages, digitize the audio messages, etc.

In an example of speech recognition processing which may be implemented by the conversion module, a speech recognition engine transforms audio/speech data (e.g., from the microphone(s) of the PA systems 112 or 116) into recognized speech data to allow further downstream processing (as will be described in greater detail below). The speech recognition engine processes received input data into recognized speech data using acoustic models, language models, and other data models and information for recognizing the speech conveyed in the audio/speech data, and determining a best matching and/or highest scoring word sequence corresponding to the input data. In some embodiments, the front end may also include filtering units configured to reduce noise in the audio data, digitize the audio data, and divide the digitized audio data into frames representing time intervals for which the acoustic front end may determine a number of values, called features, representing the qualities of the audio data, along with a set of those values, called a feature vector, representing the features/qualities of the audio data within the frame. Many different features may be determined, and each feature may represent some quality of the audio that may be useful for speech recognition processing. In embodiments in which the conversion module 130 includes a filtering unit, a number of approaches may be used by the to process the audio data, such as mel-frequency cepstral coefficients (MFCCs), perceptual linear predictive (PLP) techniques, neural network feature vector techniques, linear discriminant analysis, semi-tied covariance matrices, or other approaches. Having received audio input data (e.g., processed by the acoustic front end), the speech recognition engine may be configured to try and match received feature vectors to language phonemes and words as known in the stored acoustic models and language models. The speech recognition engine may compute recognition scores for the feature vectors based on acoustic information and language information. The acoustic information is used to calculate an acoustic score representing a likelihood that the intended sound represented by a group of feature vectors matches a language phoneme. The language information is used to adjust the acoustic score by considering what sounds and/or words are used in context with each other, thereby improving the likelihood that the speech recognition process will output speech results that make sense grammatically. The specific models used may be general models or may be models corresponding to a particular domain, such as airport (e.g., with data corresponding to typical airport PA announcement), stadium (with data corresponding to common or typical stadium PA announcements, etc.)

In the above example of a speech recognition technique implemented by the conversion module 130 of FIG. 1, the speech recognition engine may use a number of techniques to match feature vectors to phonemes, for example using Hidden Markov Models (HMMs) to determine probabilities that feature vectors may match phonemes. Sounds received may be represented as paths between states of the HMM and multiple paths may represent multiple possible text matches for the same sound. Following processing by the speech recognition engine, the output (e.g., text-based results) may be sent to other processing components, which may be local to the device performing the speech recognition and/or distributed across the network(s). For example, speech recognition results in the form of a single textual representation of the speech, an N-best list including multiple hypotheses and respective scores, lattice, etc., may be sent to a server configured to perform natural language understanding (NLU) processing. For example, an NLU process takes textual input (such as processed by the speech recognition engine) and attempts to make a semantic interpretation of the text. That is, the NLU process determines the meaning behind the text based on the individual words and then determine outcome or output based on that derived meaning.

With continued reference to FIG. 1, in some embodiments, the analysis module 140 can be configured to classify or associate the audio messages (e.g., recordings) from the first PA system 112 and the second PA system 114. Additionally or alternatively, the analysis module 140 may process the output data of the conversion module (e.g., PA messages). The analysis module 140 can determine message information about an audio message (or a resultant PA message generated therefrom), including such information as, for example, an origin of the audio message, a type of the audio message, one or more subscribers and/or events specifically affected by the audio message. For example, the analysis module 140 can associate information with an audio message broadcast by the first PA system 112 to indicate that the message is from an airport (e.g., Los Angeles International Airport, Terminal 4), and indicate that the message relates to a major event (e.g., evacuation) or a minor event (e.g., gate change). The analysis module 140 can further tag the audio message to indicate that the message relates a specific subscriber (e.g., paging the first subscriber 120 and/or the second subscriber 125) and/or events (e.g., a delay or gate change for a scheduled flight). The analysis and classification (or tagging) may be performed by including metadata as data records or fields appended to the data representative of the audio message or the PA messages (i.e., the output conversion data from the conversion module that processed the raw or original audio message). Although an audio message or a resultant PA message (converted by the conversion module) may include multiple pieces of information to facilitate a more efficient distribution of messages to specific subscribers, in many examples the analysis may be minimal and could include just an indication of the point of origin of the audio message or the PA message, time and date associated with the messages, and other such basic information. In such embodiments, distribution of the message may be less selective, with any subscriber determined to be associated with that basic information receiving all audio messages and PA messages associated with the particular PA system of origin. In such embodiments, a subscriber may receive a large volume of audio messages or PA messages associated with the particular PA system, and an application installed on the subscriber's device may select for presentation only those messages that further match some attribute or keyword provided by, or determined for, the user. For example, a subscriber's device may receive all messages originating from Terminal 4 of the LA airport, and a PA notification application running on the subscriber device may present (play) only messages pertaining to certain keywords associated with the subscriber (e.g., the specific destination the subscriber is heading to, the flight number the subscriber is scheduled on, etc.)

The publishing module 150 of the central controller 110 is configured to distribute the processed audio messages (also referred to as PA messages) and/or a recording of the audio message, to the appropriate subscribers via the PA system 112 or 116. For example, in response to a determination that a particular subscriber needs to receive messaging data (e.g., the original audio data or the PA message generated by the conversion module 130), the central controller can communicate the data, via the network 102, to the PA system corresponding to the original audio message. The publishing module 150 may be configured to distribute to a subscriber (e.g., the first subscriber 120 or the second subscriber 125) only those audio messages (or resultant PA messages) that are relevant to that subscriber (e.g., if a subscriber checked-in to a particular flight, and has provided a network ID or phone number as part of the check-in process). The publishing module 150 can identify the appropriate subscribers to receive a particular audio message (or corresponding resultant PA messages) by matching subscriber attributes and determined message information associated with the audio messages or the PA messages.

For instance, the publishing module 150 can determine whether to transmit (e.g., text, push notification, CMAS notification) a processed audio message and/or an original recording of the audio message to the first subscriber 120 if that audio message designates (or is determined to be associated with) the first subscriber 120 as a recipient (e.g., paging the first subscriber 120). The first subscriber 120 can be associated with attributes indicative of the subscribers current location (e.g., as determined, for example, by a subscriber tracking unit 155), future destinations, points of interest, and/or identity of applications installed on the first device 122 of the first user 120. According to some embodiments, some points of interest may correspond to and/or be determined based on the applications installed on the first device 122 of the first user 120.

For example, the publishing module 150 can determine whether to cause an audio message, or a corresponding resultant PA message, to be transmitted from the first PA system 112 (e.g., by sending a text message, transmit a push notification, transmit commercial mobile alert system (CMAS) notifications) to the first subscriber 120 if the first subscriber 112 is currently present at Terminal 4 of the Los Angeles International Airport, due to arrive there, and/or if the first subscriber 120 has set that location as a point of interest. In some embodiments, the first subscriber 120 can be associated with attributes indicative of certain events (e.g., flight, concert). Here, the publishing module 150 can cause an audio message or output conversion data (i.e., a generated PA message) to be transmitted from the first PA system 112 to the first subscriber 120 if the audio message or the resultant PA message relates to that event (e.g., delay and/or gate change for a certain flight). However, as noted, the publishing module 150 will generally identify a relatively large group of subscribers to which to send notifications based on such information as of the location of the PA system and other such basic information, resulting in that group of subscribers receiving a large number of notification of varying relevance or importance to the users. Further selection of which notifications to present to a particular subscriber may be performed at the subscriber's device (based on information particular to the subscriber, which may have been provided directly by the subscriber, or determined through other applications, such as the subscriber's calendar, with which the PA notification application can communicate).

In some embodiments, the publishing module 150 can further determine to cause an audio message or a PA message to be transmitted from the first PA system 112 to the first subscriber 120 if the first subscriber is determined to have a relevant application, configured to detect and/or process incoming messages formatted or communicated according to a particular communication protocol, installed on the first device 122 (e.g., flight tracker application, airline application). The determination of whether a particular device has an application required to process a particular messaging protocol may be based on previously provided data that indicates that a user installed and or activated the application (e.g., when checking in for a flight, the user authorized receipt of messages through an SMS protocol or through e-mail, and/or accepted installation of a needed application configured to detect and process relevant PA messages).

In another example, the publication module 150 may select to cause transmission of CMAS messages if it cannot be determined that the user's device is capable of receiving the processes PA message via some other communication link (e.g., messages sent via a short range, WLAN, or WWAN transmission, with such messages then processed by a previously installed and activated application such as a generic SMS messaging application, or a customized PA notification application). In such embodiments, the publication module may cause (by sending controlling messages to appropriate servers and network nodes in communication with the particular PA system that is to transit the message) transmission of the resultant PA message or the original audio message to a destination device by having the PA message or the original audio message transmitted through a communication channel dedicated for transmissions of CMAS alerts to the particular device (different devices may be configured to monitor and respond to CMAS alerts using different communication protocols and formats). In some embodiments, the publication module 150 may determine that a PA message generated by the conversion module 130 should be transmitted to a particular user's device using multiple communication protocols (e.g., sending duplicates of the message via SMS and CMAS notifications).

As noted, the publishing module 150 may also be configured, e.g., through its subscriber tracking unit 155, to facilitate determination of an estimated/approximate location for a particular user that is otherwise associated with an event with respect to which one of the PA systems is to generate an announcement. Location of a user's device may be determined in response to a user activating an application on that user's device that causes the location of the user's device to be determined and communicated to the publishing module 150 PA system (e.g., via a communication channel that may have been established over a wireless and/or wired network, between the subscriber's device and the central controller 110). Location determination may be established based on one or more of several techniques, including localization techniques that are based on RF signals from multiple satellite vehicles (such as the satellite 180 depicted in FIG. 1) and/or from terrestrial network nodes (e.g., multilateration techniques), detection of signals from near-by network nodes (e.g., a user device detecting a signal from a WLAN access point will indicate that the device is within some associated radius from that access point), detecting and responding to RF signals from short-range access nodes (e.g., BLE iBeacon advertisements transmitted by BLE nodes, who receive, in response to the advertisement, reply messages from devices with suitable BLE interfacing circuitry), etc. In some embodiments, location determination may also be derived based on image data captured by cameras deployed in various public areas that can recognize (via face recognition, or through other biometric indicators) a user. Thus, in such embodiments, the location of a device may be determined, and a PA message (e.g., generated, from raw audio data by the conversion module 130) may be transmitted to a user by one of the PA systems if there is a match between the tagged data associated with the PA message or the original audio message and user attributes, and the location of the device is within a particular range from the location of the PA system for which the PA message (original audio data and/or processed audio message) was generated.

In some implementations of the current subject matter, the acoustic messaging system 100 can be configured to queue audio messages from the first PA system 112 and/or the second PA system 114 based on a priority associated with each audio message. As such, higher priority PA messages (original raw data or processed audio message generated by the conversion module 130) may be prioritized, e.g., by the analysis module 140, which may assign a priority value to one or more of the audio messages, and transmitted (e.g., by the publishing module 150) to subscribers before lower priority audio messages.

The central controller 110 may optionally include the translation module 160 which is configured to translate audio messages from the first PA system 112 and/or the second PA system 116 into different languages. As such, the first subscriber 120 and/or the second subscriber 125 are able to select individual language preferences. Alternatively, the publishing module 150 may be configured to determine or infer from user attributes (e.g., user preferences specified via an application running on the user device, attributes, such as nationality, indicated from information provided by the user during a check-in process to a flight, etc.) The publishing module 150 is able to provide the content conveyed in the audio messages or PA message in one or more languages consistent with the language preference set by each subscriber, or determined for the subscriber. The translation module 160 can provide machine translations of processed audio messages (e.g., audio messages transcribed to a text-based representation using, for example, a speech recognition engine that may be implemented as part of the conversion module 130). Alternately or additionally, the translation module 160 can interface (e.g., via a network connection, be it a wired or wireless connection, from the central controller to another network node) with human translators to provide translations of the messages. In particular, human translators may be engaged when necessary in order to provide translations of messages that cannot be properly processed by machine translation. For instance, human translators may be able to provide translations of audio messages having features including, for example, dialects and accents.

In some implementations of the current subject matter, the first subscriber 120 and/or the second subscriber 125 can set different keywords including, for example, a name, a flight number, and a location of interest. Alternatively, such keywords may be determined from information available at the subscriber's device (e.g., at the subscriber's calendar application, which includes details about upcoming events, such as concerts, flights, etc.) The acoustic messaging system 100 can be configured to send messages to the first subscriber 120 and/or the second subscriber 125 based on the keywords when such keywords have been communicated to the system (e.g., sent to the publishing module 150). For example, the first subscriber 120 can set one or more keywords corresponding to a name of the first subscriber 120. Accordingly, the acoustic messaging system 100 can be configured to transmit to the first device 122 of the first user 120 messages that contain the name of the first subscriber 120. As noted, in some embodiments, keywords and other information may not have been communicated to the central controller 110, and thus, in such embodiments, all users that are associated with the PA system that is broadcasting a notification (e.g., users physically present at the geographic area covered by the PA system, or users that are supposed to be present based on information that was provided to the central controller) will receive all notifications sent by the PA system (e.g., a user not present at the area covered by the PA system will nevertheless receive a notification is previously provided information indicates that that user is supposed to be at the corresponding area during some time window). The publishing module may be able to further winnow the list of subscribers that are to receive a particular notification based on whatever information the publishing module has.

In some implementations of the current subject matter, the first subscriber 120 and/or the second subscriber 125 can select to receive certain messages from the acoustic messaging system 100. For instance, the first subscriber 120 can electively subscribe to messages broadcast by the first PA system 112 at, for instance, Terminal 4 of the Los Angeles International Airport. As such, the acoustic messaging system 100 can be configured to transmit messages from the first PA system 112 to the first subscriber 120 even when the first subscriber 120 is not currently and/or scheduled to be present at Terminal 4. As noted, in some situations, the current location of the user (or the user's device) can be a criterion used to determine (e.g., by the publishing module 150 and/or its tracking unit 144) whether or not to send a PA message. For example, a PA message may be communicated to the user device in response to a determination that the user's device is within a certain geographical area, and further based on other criteria that are evaluated based on a match between one or more of the tags associated with the PA message and corresponding one or more attributes associated with the user or the user's device.

In some embodiments, the audit module 170 can be configured to store and archive one or more processed messages (e.g., in a data store 175). The audit module 170 can be further configured to store and archive the corresponding audio messages (e.g., in the data store 175). Whereas conventional PA systems generally do not archive messages that have been broadcast, the audit module 170 is configured to maintain an archive of processed and/or original audio messages, which may be used, for example, for tracking and/or forensic purposes. Additionally, previous announcement may be retrieved from the data store 175 in order to be re-transmitted (as broadcasts or unicasts to specific users who may not have received or acknowledged the original transmissions). In some embodiments, the data store may also be used to implement a PA announcement queue that arranged messages to be transmitted according to associated priority values (e.g., determined by the tagging module 140).

As noted, in some implementations, an application (not shown) can be deployed/installed at the first device 122, the second device 126, and/or the third device 128 that allows the first subscriber 120 and/or the second subscriber 125 to receive notifications from the acoustic messaging system 100. The application can be further integrated with a calendar application such that the mobile application is able to determine, based on events scheduled in a subscriber's calendar, one or more events and/or locations that are relevant to that subscriber or to another application installed on the subscriber's device. The application can select from PA notifications received from the PA system which notifications (original audio message or a PA message) to present (play) to the user.

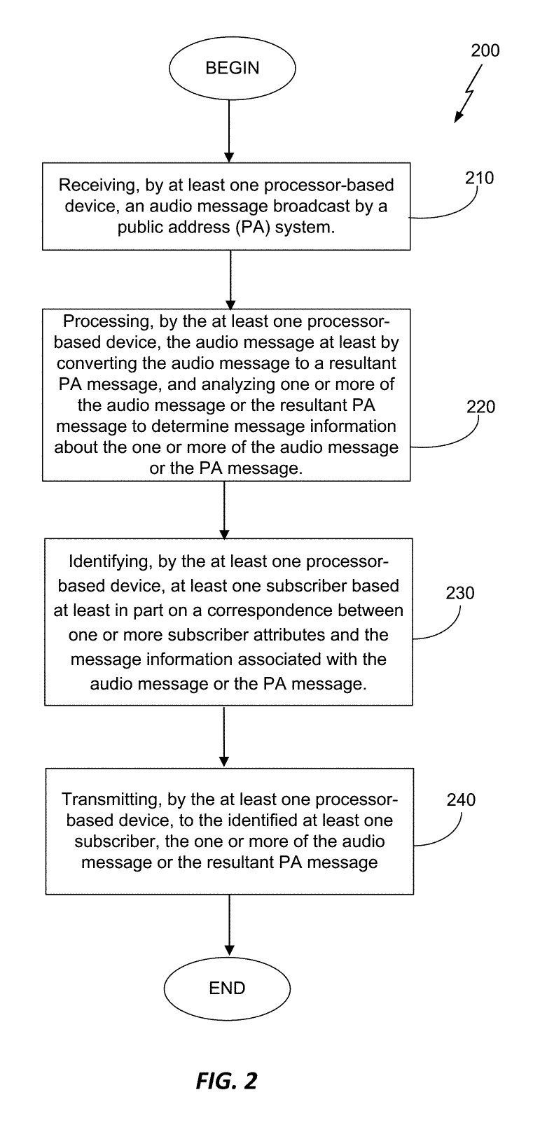

With reference next to FIG. 2, a flowchart of a process 200 for converting and distributing PA system messages is shown. The process 200 can be performed by the acoustic messaging system 100, e.g., at the central controller 110 of the system. As illustrated, the process 200 includes receiving 210, by at least one processor-based device (e.g., the central controller 110), an audio message broadcast by a public address (PA) system. For example, the acoustic messaging system 100 can receive a recording of an audio message that was broadcast by the first PA system 112 (e.g., installed at an airport). Alternately or additionally, the acoustic messaging system 100 can receive a recording of an audio message that was broadcast by the second PA system 114 (e.g., installed at a stadium). In another example, the audio message may have been provided via a phone device connected to a PBX server.

The process 200 further includes processing 220, by the at least one processor-based device, the audio message at least by converting the audio message to a resultant PA message, and analyzing one or more of the audio message or the resultant PA message to determine message information about the one or more of the audio message or the PA message. For example, the acoustic messaging system 100 can convert the audio message by transcribing (e.g., via automatic speech recognition) the contents of the audio message into text and/or image. The acoustic messaging system 100 can further analyze (tag) the audio message to indicate, for example, the origin of the audio message, the type of the audio message, and events and/or subscribers affected by the audio message, etc. In some implementations of the current subject matter, the acoustic messaging system 100 can also translate the contents of the audio message into a plurality of different languages. In some embodiments, analyzing the one or more of the audio message or the resultant PA message may include determining message information for the one or more of the audio message or the resultant PA message indicating one or more of, for example, an origin of the audio message, a type of the audio message or the resultant PA message, one or more subscribers affected by the audio message or the resultant PA message, and/or one or more events affected by the one or more of the audio message or the resultant PA message.

The process 200 further includes identifying 230, by the at least one processor-based device, at least one subscriber based at least in part on a correspondence between one or more subscriber attributes and the message information associated with the audio message or the PA message. For example, the first subscriber 120 can be associated with attributes (if provided by the subscriber) indicating that the first subscriber 120 is scheduled for a certain flight that is departing from Terminal 4 of the Los Angeles International Airport. As such, the acoustic messaging system 100 can identify the first subscriber 120 based on a correspondence between these attributes and audio or PA messages tagged as originating from Terminal 4 of the Los Angeles International Airport and/or relating to that specific flight. As noted, in some embodiments, more detailed selection of messages to be presented to a subscriber may be done at the subscriber's device based on attributes (including keywords) that are available at the device and have not otherwise been communicated to the messaging system 100.

As additionally illustrated in FIG. 2, the process 200 includes transmitting 240, by the at least one processor-based device, to the identified subscriber, the one or more of the audio message or the resultant PA message. For example, the acoustic messaging system 100 (e.g., via the publishing module 150 depicted in FIG. 1) can transmit the transcribed contents of the audio or PA message to the first subscriber 120 via an SMS text, push notifications, haptic notifications, CMAS notifications, and all other notification mechanism that are supported by a particular device that is to receive the notification, and by the availability of network nodes that can receive processed PA messages generated from the original audio message, and communicate the notifications to the device.

In some embodiments, the process 200 may further include receiving another audio message from a same or different PA system, and prioritizing a transmission of the audio message and the other audio message based at least in part on a respective type of the audio message and the other audio message. In some implementations, the process 200 may further include storing (e.g., in storage such as the data store 175 of FIG. 1) a recording of the one or more of the audio message or the resultant PA message , and providing the recording of the one or more of the audio message or the resultant PA message for an audit of the PA system.

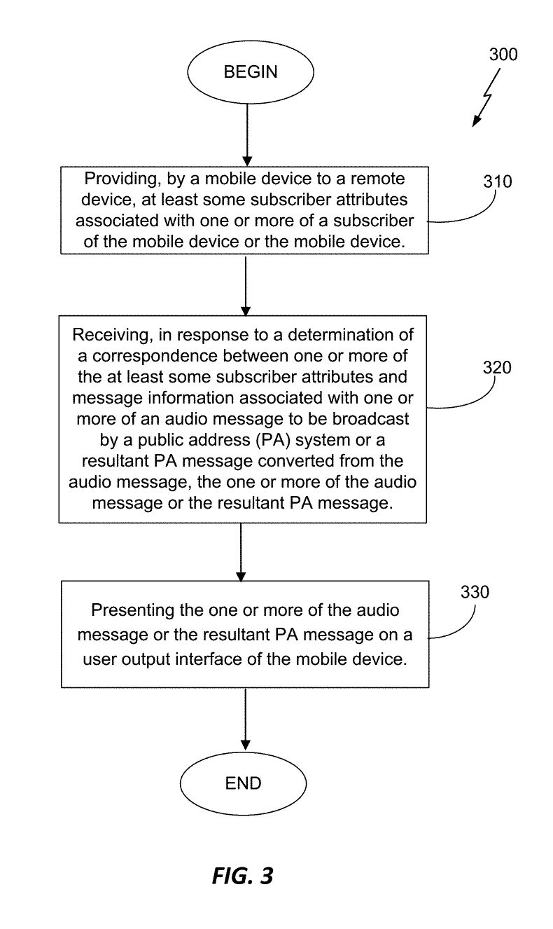

With reference next to FIG. 3, a flowchart of an example process 300 for receiving PA messages/notifications, generally performed at a mobile device (at which an application capable of supporting receipt and presentation of PA notifications of the types processed and published by the acoustic messaging system 100), is shown. The process 300 includes providing 310, by a mobile device (e.g., the user device, such as the devices 122, 126, or 128 depicted in FIG. 1) to a remote device (such as the central controller 110), at least some subscriber attributes associated with one or more of a subscriber of the mobile device or the mobile device. Providing the at least some subscriber attributes may include providing one or more of a subscriber's current location (as determined by the device through one of various location determination techniques, or as determined by a remote location server), one or more points of interest, one or more events associated with the subscriber, or one or more applications installed on the device of the subscriber.

The process 300 further includes receiving 320, in response to a determination of a correspondence between one or more of the at least some subscriber attributes and message information associated with one or more of an audio message to be broadcast by a public address (PA) system or a resultant PA message converted from the audio message, the one or more of the audio message or the resultant PA message. The message information may include one or more of, for example, an origin of the audio message, a type of the audio message or the resultant PA message, one or more subscribers affected by the audio message or the resultant PA message, or one or more events affected by the one or more of the audio message or the resultant PA message. In some embodiments, receiving the one or more of the audio message or the resultant PA message may include receiving the one or more of the audio message or the resultant PA message in response to a determination of whether the subscriber's current location is within a predetermined radius from a geographic location corresponding to the original of the audio message.

The process 300 also includes presenting 330 the one or more of the audio message or the resultant PA message on a user output interface of the mobile device (e.g., implemented using an installed application to support receipt and notification of PA messages). In some embodiments, presenting the one or more of the audio message or the resultant PA message may include selecting, from a plurality of audio messages and PA messages received at the mobile device, at least one message to present on the user output interface, based on the subscriber attributes, wherein the subscriber attributes include one or more keyword determined to be associated with the subscriber. For example, an application installed at the subscriber's device can determine various keywords (provided directly by the subscriber, or determined from information available at the device, e.g., through the subscriber's calendar), and match those keywords to PA notifications received from a PA system. The application can then select and play only those notification that meet certain criteria (e.g., match one or more of the keyword, such as a destination to which the subscriber is flying, flight number, words connoting an emergency situation, etc.)

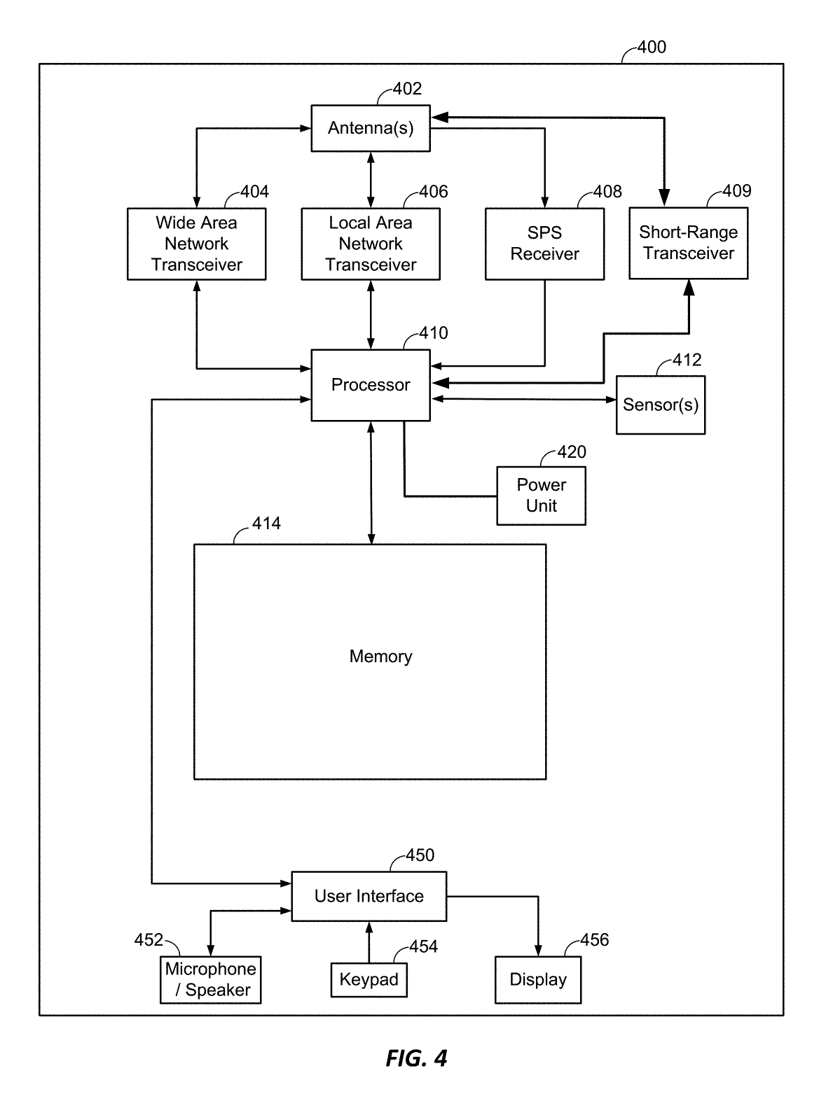

With reference now to FIG. 4, a schematic diagram of an example device 400, which may be used to implement, at least in part, the various devices, nodes, and elements depicted in FIG. 1, including, for example, the central controller 110, the subscriber devices 122, 126, or 128, the PA systems 112 and 116, and/or any of the network nodes or other devices depicted in FIG. 1. It is to be noted that one or more of the modules and/or functions illustrated in the example of FIG. 4 may be further subdivided, or two or more of the modules or functions illustrated in FIG. 4 may be combined. Additionally, one or more of the modules or functions illustrated in FIG. 4 may be excluded.

As shown, the example device 400 may include one or more transceivers (e.g., a LAN transceiver 406, a WLAN transceiver 404, a short-range transceiver 409, etc.) that may be connected to one or more antennas 402. The transceivers 404, and 406, and/or 409 may comprise suitable devices, hardware, and/or software for communicating with and/or detecting signals to/from a network or remote devices, and/or directly with other wireless devices within a network. In some embodiments, by way of example only, the transceiver 406 may support wireless LAN communication (e.g., WLAN, such as WiFi-based communications) to thus cause the device 400 to be part of a WLAN implemented as an IEEE 802.11x network. In some embodiments, the transceiver 404 may support the device 400 to communicate with one or more cellular access points (also referred to as a base station) used in implementations of Wide Area Network Wireless Access Points, which may be used for wireless voice and/or data communication. All types of cellular and/or wireless communications networks may be supported by the transceiver 404 of the device 400. As noted, in some variations, the device 400 may also include a near-field transceiver (interface) configured to allow the device 400 to communicate according to one or more near-field communication protocols, such as, for example, Ultra-Wide Band, ZigBee, wireless USB, Bluetooth® (classical Bluetooth), Bluetooth-Low-Energy® (BLE) protocol, etc. As further illustrated in FIG. 4, in some embodiments, an SPS receiver 408 may also be included in the device 400. The SPS receiver 408 may be connected to the one or more antennas 402 for receiving satellite signals. The SPS receiver 408 may comprise any suitable hardware and/or software for receiving and processing SPS signals. The SPS receiver 408 may request information as appropriate from other systems, and may perform the computations necessary to determine the device's 400 position using, in part, measurements obtained by any suitable SPS procedure. Such positioning information may be used, for example, to determine the location and motion of a subscriber device, to allow determination of whether a particular PA message should be communicated to that subscribed device.

In some embodiments, one or more sensors 412 may be coupled to a controller 410 to provide data that includes relative movement and/or orientation information. By way of example but not limitation, sensors 412 may utilize an accelerometer (e.g., a MEMS device), a gyroscope, a geomagnetic sensor (e.g., a compass), and/or any other type of sensor. Moreover, sensor 412 may include a plurality of different types of devices and combine their outputs in order to provide motion information. The one or more sensors 412 may further include an altimeter (e.g., a barometric pressure altimeter), a thermometer (e.g., a thermistor), an audio sensor (e.g., a microphone), a camera or some other type of optical sensors (e.g., a charge-couple device (CCD)-type camera, a CMOS-based image sensor, etc., which may produce still or moving images that may be displayed on a user interface device, and that may be further used to determine an ambient level of illumination and/or information related to colors and existence and levels of UV and/or infra-red illumination), and/or other types of sensors. Data measured by the sensors 412 may be used to produce additional user attributes information that can provided to the acoustic messaging system 100 (e.g., to determine if a particular PA message or audio message should be communicated to the measuring device).

The controller 410 may include one or more microprocessors, microcontrollers, and/or digital signal processors, and customized control circuitry (e.g., implemented as application-specific-integrated-circuits, or ASIC) that provide processing functions, as well as other computations and control functionality. The controller 410 may also include memory 414 for storing data and software instructions for executing programmed functionality within the device. The functionality implemented via software may depend on the particular device at which the memory 414 is housed, and the particular configuration of the device and/or the devices with which it is to communicate. For example, if the device 400 is used to implement a controller such as the central controller 110 of FIG. 1, the device 400 may be configured (via software modules/applications provided on the memory 414) to implement a process to receive and process audio messages from PA systems. Where the device 400 is used to implement a subscriber device, the device may be configured to provide user attributes, and receive and present PA notifications. The memory 414 may be on-board the processor 410 (e.g., within the same IC package), and/or the memory may be external memory to the processor and functionally coupled over a data bus.

With continued reference to FIG. 4, the device 400 may include a power unit 420 such as a battery and/or a power conversion module that receives and regulates power from an outside source (e.g., AC power, in situations where the device 400 is used to implement a mobile or stationary device to control a lock device). The example device 400 may further include a user interface 450 which provides any suitable interface systems, such as a microphone/speaker 452, keypad 454, and display 456 that allows user interaction with the mobile device 400. A user interface, be it an audiovisual interface (e.g., a display and speakers) of a mobile device, or some other type of interface (visual-only, audio-only, tactile, etc.), are configured to present PA messages or PA audio message, provide status data, and so on, to a user using the particular device 400. The microphone/speaker 452 provides for voice communication functionality, the keypad 454 includes suitable buttons for user input, the display 456 includes any suitable display, such as, for example, a backlit LCD display, and may further include a touch screen display for additional user input modes.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine readable medium can alternatively or additionally store such machine instructions in a transient manner, such as for example as would a processor cache or other random access memory associated with one or more physical processor cores.

The above implementations, as illustrated in FIGS. 1-4, are applicable to a wide range of technologies that include RF technologies (including WWAN technologies, such as cellular technologies, and WLAN technologies), satellite communication technologies, cable modem technologies, wired network technologies, optical communication technologies, and all other RF and non-RF communication technologies. The implementations described herein encompass all techniques and embodiments that pertain to use of multiband digital predistortion in various different communication systems.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate in the context of the systems, devices, circuits, methods, and other implementations described herein.

As used herein, including in the claims, “or” as used in a list of items prefaced by “at least one of” or “one or more of” indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.). Also, as used herein, unless otherwise stated, a statement that a function or operation is “based on” an item or condition means that the function or operation is based on the stated item or condition and may be based on one or more items and/or conditions in addition to the stated item or condition.

Although particular embodiments have been disclosed herein in detail, this has been done by way of example for purposes of illustration only, and is not intended to be limit the scope of the invention, which is defined by the scope of the appended claims.

Features of the disclosed embodiments can be combined, rearranged, etc., within the scope of the invention to produce more embodiments. Some other aspects, advantages, and modifications are considered to be within the scope of the claims provided below. The claims presented are representative of at least some of the embodiments and features disclosed herein. Other unclaimed embodiments and features are also contemplated.

What is claimed is:

1. A method comprising:
receiving, by at least one processor-based device, an audio message broadcast by a public address (PA) system;
processing, by the at least one processor-based device, the audio message at least by converting the audio message to a resultant PA message, and analyzing one or more of the audio message or the resultant PA message to determine message information about the one or more of the audio message or the PA message;
identifying, by the at least one processor-based device, at least one subscriber based at least in part on a correspondence between one or more subscriber attributes and the message information associated with the audio message or the PA message; and
transmitting, by the at least one processor-based device, to the identified at least one subscriber, the one or more of the audio message or the resultant PA message.

2. The method of claim 1, wherein converting the audio message includes transcribing at least a portion of a content of the audio message into one more of text or image.

3. The method of claim 2, wherein the transcribing is performed via an automated speech recognition.

4. The method of claim 1, wherein analyzing the one or more of the audio message or the resultant PA message comprises:
determining for the one or more of the audio message or the resultant PA message the message information indicating one or more of: an origin of the audio message, a type of the audio message or the resultant PA message, one or more subscribers affected by the audio message or the resultant PA message, or one or more events affected by the one or more of the audio message or the resultant PA message.

5. The method of claim 1, wherein subscriber attributes indicate one or more of a subscriber's current location, one or more points of interest, one or more events associated with the subscriber, or one or more applications installed on a device of the subscriber.

6. The method of claim 1, further comprising translating the processed audio message into a plurality of different languages.

7. The method of claim 6, wherein the transmitting of the audio message includes selecting a translation of the processed audio message in a language that is consistent with a language preference of the subscriber.

8. The method of claim 1, further comprising receiving another audio message from a same or different PA system, and prioritizing a transmission of the audio message and the other audio message based at least in part on a respective type of the audio message and the other audio message.

9. The method of claim 1, further comprising storing a recording of the one or more of the audio message or the resultant PA message, and providing the recording of the one or more of the audio message or the resultant PA message for an audit of the PA system.

10. A system comprising:
a communication transceiver to receive an audio message broadcast by a public address (PA) system; and
a processor-based device, coupled to a memory device storing instructions executable on the processor-based device, implementing:
a conversion module to convert the audio message to a resultant PA message;
an analysis module to analyze one or more of the audio message or the resultant PA message to determine message information about the one or more of the audio message or the PA message;
a publishing module configured to:
identify at least one subscriber based at least in part on a correspondence between one or more subscriber attributes and the message information associated with the audio message or the PA message; and
cause the one or more of the audio message or the resultant PA message to be communicated to the identified at least one subscriber.

11. The system of claim 10, wherein the conversion module configured to convert the audio message is configured to:
transcribe using automated speech recognition engine at least a portion of a content of the audio message into one more of text or image.

12. The system of claim 10, wherein the analysis module configured to analyze the one or more of the audio message or the resultant PA message is configured to:
determine for the one or more of the audio message or the resultant PA message the message information indicating one or more of: an origin of the audio message, a type of the audio message or the resultant PA message, one or more subscribers affected by the audio message or the resultant PA message, or one or more events affected by the one or more of the audio message or the resultant PA message.

13. The system of claim 10, wherein subscriber attributes indicate one or more of a subscriber's current location, one or more points of interest, one or more events associated with the subscriber, or one or more applications installed on a device of the subscriber.

14. The system of claim 10, further comprising:
a translation module to translate the processed audio message into a plurality of different languages.

15. The system of claim 10, further configured to:
receive another audio message from a same or different PA system; and
prioritize a transmission of the audio message and the other audio message based at least in part on a respective type of the audio message and the other audio message.

16. A method comprising:
providing, by a mobile device to a remote device, at least some subscriber attributes associated with one or more of a subscriber of the mobile device or the mobile device;
receiving, in response to a determination of a correspondence between one or more of the at least some subscriber attributes and message information associated with one or more of an audio message to be broadcast by a public address (PA) system or a resultant PA message converted from the audio message, the one or more of the audio message or the resultant PA message; and
presenting the one or more of the audio message or the resultant PA message on a user output interface of the mobile device.

17. The method of claim 16, wherein providing the at least some of the subscriber attributes comprises:
providing one or more of a subscriber's current location, one or more points of interest, one or more events associated with the subscriber, or one or more applications installed on a device of the subscriber.

18. The method of claim 16, wherein the message information comprises one or more of: an origin of the audio message, a type of the audio message or the resultant PA message, one or more subscribers affected by the audio message or the resultant PA message, or one or more events affected by the one or more of the audio message or the resultant PA message.

19. The method of claim 16, wherein receiving the one or more of the audio message or the resultant PA message comprises:
receiving the one or more of the audio message or the resultant PA message in response to a determination of whether the subscriber's current location is within a predetermined radius from a geographic location corresponding to the original of the audio message.

20. The method of claim 16, wherein presenting the one or more of the audio message or the resultant PA message comprises:
selecting, from a plurality of audio messages and PA messages received at the mobile device, at least one message to present on the user output interface, based on the subscriber attributes, wherein the subscriber attributes include one or more keyword determined to be associated with the subscriber.
